(19) United States
(12) Patent Application Publication
(10) Pub. No.: US 2024/0373257 A1
(43) Pub. Date: Nov. 7, 2024

(54) INFORMATION INTERACTION METHOD AND APPARATUS, AND COMMUNICATION DEVICE

(71) Applicant: VIVO MOBILE COMMUNICATION CO., LTD., Dongguan (CN)

(72) Inventors: Yuan SHI, Dongguan (CN); Peng SUN, Dongguan (CN)

(73) Assignee: VIVO MOBILE COMMUNICATION CO., LTD., Dongguan (CN)

(21) Appl. No.: 18/772,171

(22) Filed: Jul. 13, 2024

Related U.S. Application Data
(63) Continuation of application No. PCT/CN2023/071475, filed on Jan. 10, 2023.

(30) Foreign Application Priority Data
Jan. 14, 2022 (CN) 202210041900.5

(51) Int. Cl. H04W 24/02; H04B 7/06; H04B 17/318; H04W 16/28

(52) U.S. Cl. CPC H04W 24/02; H04B 7/06968; H04B 17/328; H04W 16/28

(57) ABSTRACT

This application discloses an information interaction method and apparatus, and a communication device. The method includes: indicating, by a first communication device, first interaction information, where the first interaction information is used to indicate at least one of the following: a beam-related usage of an artificial intelligence AI model; parameter information corresponding to the beam-related usage of the AI model, where the parameter information includes at least one of input parameter information, output parameter information, and auxiliary parameter information; quantity information related to the parameter information; and order information of the parameter information.

### CROSS-REFERENCE TO RELATED APPLICATIONS

This application is a continuation of International Application No. PCT/CN2023/071475, filed on Jan. 10, 2023, which claims priority to Chinese Patent Application No. 202210041900.5, filed Jan. 14, 2022. The entire contents of each of the above-identified applications are expressly incorporated herein by reference.

### TECHNICAL FIELD

This application pertains to the field of communication technologies, and specifically relates to an information interaction method and apparatus, and a communication device.

### BACKGROUND

Currently, in a conventional beam alignment method, more reference signal resources are sent on one side, and on the other side, beam quality information corresponding to each reference signal resource is received and calculated, and an optimal beam and the beam quality information are fed back. The sent reference signal resources occupy a lot of time domain resources, and beam quality corresponding to an unsent reference signal resource cannot be obtained on the other side, and consequently a selected beam is not globally optimal. Although Artificial Intelligence (AI) is widely used in various fields, there is no explicit solution for how to implement a beam-related usage (for example, a beam alignment usage) based on the AI.

### SUMMARY

Embodiments of this application provide an information interaction method and apparatus, and a communication device.

According to a first aspect, an information interaction method is provided, including:
indicating, by a first communication device, first interaction information, where the first interaction information is used to indicate at least one of the following:
a beam-related usage of an artificial intelligence AI model;
parameter information corresponding to the beam-related usage of the AI model,
   where the parameter information includes at least one of input parameter information, output parameter information, and auxiliary parameter information;
quantity information related to the parameter information; and
order information of the parameter information.

According to a second aspect, an information interaction method is provided, including:
obtaining, by a second communication device, first interaction information, where the first interaction information is obtained through indication of a first communication device and/or through protocol stipulation, where
the first interaction information is used to indicate at least one of the following:
a beam-related usage of an artificial intelligence AI model;
parameter information corresponding to the beam-related usage of the AI model,
   where the parameter information includes at least one of input parameter information, output parameter information, and auxiliary parameter information;
quantity information related to the parameter information; and
order information of the parameter information.

According to a third aspect, an information interaction apparatus is provided, including:
a first interaction module, configured to indicate first interaction information, where the first interaction information is used to indicate at least one of the following:
a beam-related usage of an artificial intelligence AI model;
parameter information corresponding to the beam-related usage of the AI model,
   where the parameter information includes at least one of input parameter information, output parameter information, and auxiliary parameter information;
quantity information related to the parameter information; and
order information of the parameter information.

According to a fourth aspect, an information interaction apparatus is provided, including:
a second interaction module, configured to obtain first interaction information,
   where the first interaction information is obtained through indication of a first communication device and/or through protocol stipulation, where
the first interaction information is used to indicate at least one of the following:
a beam-related usage of an artificial intelligence AI model;
parameter information corresponding to the beam-related usage of the AI model,
   where the parameter information includes at least one of input parameter information, output parameter information, and auxiliary parameter information;
quantity information related to the parameter information; and
order information of the parameter information.

According to a fifth aspect, a communication device is provided. The terminal includes a processor and a memory, where the memory stores a program or an instruction that can be run on the processor, and the program or the instruction is executed by the processor to implement the steps of the method according to the first aspect or the second aspect.

According to a sixth aspect, a communication device is provided, including a processor and a communication interface. The processor or the communication interface is configured to indicate first interaction information; or the processor and/or the communication interface are/is configured to obtain first interaction information, where the first interaction information is obtained through indication of a first communication device and/or through protocol stipulation, where
the first interaction information is used to indicate at least one of the following:
a beam-related usage of an artificial intelligence AI model;
parameter information corresponding to the beam-related usage of the AI model,
   where the parameter information includes at least one of input parameter information, output parameter information, and auxiliary parameter information;
quantity information related to the parameter information; and
order information of the parameter information.

According to a seventh aspect, an information interaction system is provided, including a first communication device and a second communication device. The first communication device may be configured to perform the steps of the information interaction method according to the first aspect, and the second communication device may be configured to perform the steps of the information interaction method according to the second aspect.

According to an eighth aspect, a readable storage medium is provided, where the readable storage medium stores a program or an instruction, and the program or the instruction is executed by a processor to implement the steps of the method according to the first aspect or the steps of the method according to the second aspect.

According to a ninth aspect, a chip is provided. The chip includes a processor and a communication interface, the communication interface is coupled to the processor, and the processor is configured to run a program or an instruction to implement the method according to the first aspect or the method according to the second aspect.

According to a tenth aspect, a computer program product is provided. The computer program product is stored in a storage medium, and the computer program product is executed by at least one processor to implement the steps of the method according to the first aspect.

### BRIEF DESCRIPTION OF DRAWINGS

FIG. 1 is a block diagram of a communication system to which the embodiments of this application can be applied;

FIG. 2 is a first flowchart of an information interaction method according to an embodiment of this application;

FIG. 3 is a second flowchart of an information interaction method according to an embodiment of this application;

FIG. 4 is a first block diagram of modules of an information interaction apparatus according to an embodiment of this application;

FIG. 5 is a second block diagram of modules of an information interaction apparatus according to an embodiment of this application;

FIG. 6 is a first block diagram of a communication device according to an embodiment of this application;

FIG. 7 is a block diagram of a terminal according to an embodiment of this application;

FIG. 8 is a first block diagram of a network side device according to an embodiment of this application; and

FIG. 9 is a second block diagram of a network side device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first,” “second,” and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

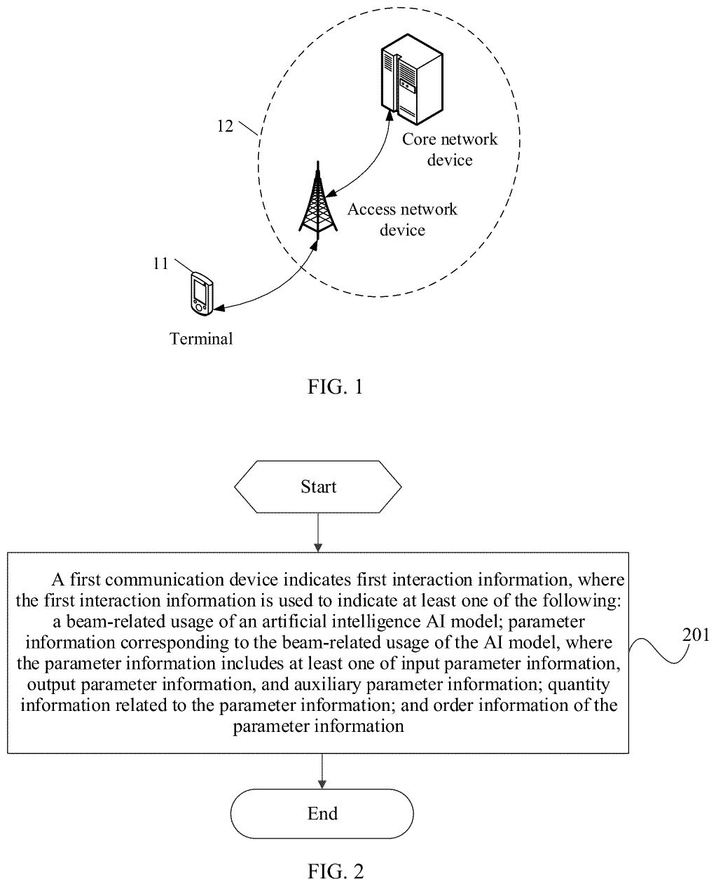

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a personal computer, a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access point, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

To enable a person skilled in the art to better understand the embodiments of this application, the following descriptions are provided first.

### 1. Artificial Intelligence

Currently, artificial intelligence is widely used in various fields. An AI network has various implementations, such as a neural network, a decision tree, a support vector machine, and a Bayesian classifier. In this application, a neural network is used as an example for description, but a specific type of the AI network is not limited.

The neural network is composed of neurons. The neurons may include inputs a₁, a₂, . . . a_{K}, a weight (multiplicity coefficient) w, an offset (additive coefficient) b, and an activation function σ(.). Common activation functions include Sigmoid, tanh, a rectified linear unit (Rectified Linear Unit, ReLU), and the like, where the ReLU is a linear rectifier function. The neural network may be represented as z=a₁*w₁+ . . . +aₖ*wₖ+ . . . a_{K}*w_{K}+b.

Parameters of the neural network are optimized by using an optimization algorithm. The optimization algorithm is an algorithm for minimizing or maximizing an objective function (sometimes called a loss function). The objective function is often a mathematical combination of a model parameter and data. For example, data X and a corresponding label Y are given, and a neural network model f(.) is constructed. Based on the neural network model, a predicted output f(x) may be obtained according to the input x, and a difference (f(x)-Y) between a predicted value and a real value may be calculated. This is the loss function. The purpose is to find proper w and b to minimize a value of the above loss function. If a loss value is smaller, the model closer is to a real situation.

Currently, common optimization algorithms are basically based on an error (error) Back Propagation (BP) algorithm. A basic idea of the BP algorithm is that a learning process consists of two processes: signal forward propagation and error back propagation. During forward propagation, an input sample is transferred from an input layer to an output layer after being processed by each hidden layer. If an actual output of the output layer does not match an expected output, error back propagation is performed. Error back propagation is to transmit an output error layer by layer to the input layer through a hidden layer in some form for back propagation, and allocate the error to all units of each layer, to obtain an error signal of a unit at each layer. This error signal is used as a basis for correcting a weight of each unit. A weight adjustment process of each layer during signal forward propagation and error back propagation is carried out repeatedly. A process of continuously adjusting a weight is a learning and training process of a network. This process continues until errors output by the network are reduced to an acceptable level or until a preset quantity of learning times are reached.

The common optimization algorithms include Gradient Descent (GD), Stochastic Gradient Descent (SGD), mini-batch gradient descent, momentum, adaptive gradient descent (Nesterov, which is random gradient descent with momentum), Root Mean Square prop (RMSprop), and Adaptive Moment Estimation (Adam).

During error back propagation, in these optimization algorithms, an error/loss is obtained according to the loss function, a gradient is obtained by calculating a derivative/partial derivative of a current neuron and adding a learning rate and a previous gradient/derivative/partial derivative, and the gradient is transferred to an upper layer.

### 2. Beam Measurement and Beam Reporting

Analog beamforming is full-bandwidth transmission, and an array element in each polarization direction on a panel of each high-frequency antenna array can only send an analog beam through time division multiplexing. A weight value of the analog beam is implemented by adjusting a parameter of a device such as a radio frequency front-end phase shifter.

Currently, a polling method is usually used to train an analog beamforming vector. To be specific, an array element in each polarization direction on each antenna panel sequentially send a training signal (that is, a candidate beamforming vector) at an appointed time through time division multiplexing, and a terminal feeds back a beam report after measurement, so that a network side can use the training signal to implement simulated beam transmission during a next service transmission. Content of the beam report generally includes several optimal transmit beam identifiers and measured receive power of each transmit beam.

During beam measurement, the network configures a reference signal resource set (RS resource set), including at least one reference signal resource, such as a synchronization signal/a Physical Broadcast CHannel signal block (or a synchronization signal block) (Synchronization Signal and PBCH block, SSB) resource or a Channel State Information Reference Signal (CSI-RS) resource. User Equipment (UE) measures Layer 1 Reference Signal Received Power (L1-RSRP)/Layer 1 Signal to Interference plus Noise Ratio (L1-SINR) of each RS resource, and reports at least one optimal measurement result to the network. Reported content includes an SSB Resource Indicator (SSBRI) or a CSI-RS Resource Indicator (CRI), and an L1-RSRP/L1-SINR. The reported content reflects at least one optimal beam and its quality for the network to determine a beam used to send a channel or a signal to the UE.

With reference to the accompanying drawings, the following describes in detail an information interaction method provided in the embodiments of this application by using some embodiments and application scenarios thereof.

As shown in FIG. 2, an embodiment of this application provides an information interaction method, including:

Step 201: A first communication device indicates first interaction information.

The first interaction information is used to indicate at least one of the following:
a beam-related usage of an artificial intelligence AI model;
parameter information corresponding to the beam-related usage of the AI model,
   where the parameter information includes at least one of input parameter information, output parameter information, and auxiliary parameter information;
quantity information related to the parameter information; and
order information of the parameter information.

In this embodiment of this application, a first communication device indicates first interaction information related to a beam to a second communication device, so that the second communication device can determine, according to the first interaction information, a beam-related usage of an artificial intelligence AI model, parameter information corresponding to the beam-related usage of the AI model, quantity information related to the parameter information, and/or order information of the parameter information, thereby implementing the beam-related usage based on the AI model.

The first communication device in this embodiment of this application includes at least one of the following: a base station, UE, and a network element corresponding to an auxiliary network central unit. The second communication device includes at least one of the following: base station, UE, and a network element corresponding to an auxiliary network central unit. The auxiliary network central unit is a unit for information interaction.

For example, in this embodiment of this application, both the first communication device and the second communication device are base stations; or both the first communication device and the second communication device are UE; or the first communication device is a base station, and the second communication device is UE; or the first communication device is UE, and the second communication device is a base station; or the first communication device is a network element corresponding to an auxiliary network central unit, and the second communication device is a base station or UE; or the first communication device is a base station or UE, and the second communication device is a network element corresponding to an auxiliary network central unit.

In some implementations, the beam-related usage of the AI model includes at least one of the following:
predicting spatial correlation information of a beam;
predicting beam information related to a target time;
adjusting a model parameter, for example, adjusting a related parameter of the AI model; and
indicating a beam relationship or a Quasi Co-Location (QCL) relationship.

In some implementations, the predicting spatial correlation information of a beam includes at least one of the following:
predicting at least one beam;
predicting at least one reference signal identifier, where the reference signal identifier is associated with beam information;
predicting angle information of at least one beam; and
predicting quality information of at least one beam.

In this embodiment of this application, beam quality information may be determined by using at least one of the following:
a Signal to Interference plus Noise Ratio (SINR);
Reference Signal Received Power (RSRP); and
Reference Signal Received Quality (RSRQ).

In some implementations, the target time includes at least one of the following:
a future time;
a historical time; and
a current time.

In some implementations, the beam information related to the target time includes at least one of the following:
beam angle information related to the target time, for example, predicating beam angle information after 10 ms; and
beam quality information related to the target time.

In other words, in this embodiment of this application, beam space-related information of the target time may be predicated by using the AI model, and the target time may be a historical time, a current time, or a future time.

In some implementations, the quantity information related to the parameter information includes at least one of the following:
quantity information of a reference signal set;
quantity information of a reference signal resource;
information about total beam measurement times;
a total quantity of beams;
a total quantity of pieces of beam quality information;
a total quantity of beam angles;
a quantity of beam measurement periods;
information about current beam measurement times;
information about historical beam measurement times;
a quantity of beams corresponding to the information about the historical beam measurement times;
a quantity of beam angles corresponding to the information about the historical beam measurement times;
a quantity of pieces of beam quality information corresponding to the historical beam measurement information;
a quantity of beams corresponding to the current beam measurement times;
a quantity of beam angles corresponding to the current beam measurement times;
a quantity of pieces of beam quality information corresponding to the current beam measurement times; and
a total quantity of inputs of the parameter information.

The quantity information may be a quantity, and the information about times may

be a quantity of times, that is, the quantity information of the reference signal set may include a quantity of reference signal sets, the quantity information of the reference signal resource may include a quantity of reference signal resources, the information about the total beam measurement times may include a total quantity of beam measurement times, and the information about the current beam measurement times may include a quantity of current beam measurement times.

It should be noted that the beam angle in this embodiment of this application includes at least one of a beam transmit angle and a beam receive angle, and the beam identifier includes at least one of a transmit beam identifier, a receive beam identifier, and a beam pair identifier, where a beam pair includes a transmit beam and a receive beam.

In some implementations, the input parameter information or the output parameter information includes at least one of the following:
an SINR;
RSRP;
RSRQ;
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal;
related information of an antenna gain;
related information of beam quality;
related information of a beam angle;
related information of a beam receive angle indicating an output of the AI model; and
related information of a beam receive identifier indicating an output of the AI model.

Each of the foregoing parameters corresponds to one parameter type.

In an embodiment of this application, the input parameter includes at least one of the following:
an SINR;
RSRP;
RSRQ;
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal;
related information of an antenna gain;
related information of a beam receive angle indicating an output of the AI model; and
related information of a beam receive identifier indicating an output of the AI model.

For example, if the AI model input includes measured beam quality, a corresponding transmit beam angle and receive beam angle, and an expected predicted receive beam angle, the output of the AI model corresponds to beam-related information when the expected predicted receive beam angle is used for receiving.

In an embodiment of this application, the output parameter includes at least one of the following:
an SINR;
RSRP;
RSRQ;
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal; and
related information of a beam angle.

In some implementations, related information of a target parameter includes at least

one of the following:
first information, where the first information directly indicates a value of the target parameter; for example, the first information is 60 degrees, that is, indicates that a beam angle is 60 degrees, or the first information is 01, that is, indicates that a beam identifier is 01; and
second information, where the second information indirectly indicates a value of the target parameter, where
the target parameter includes at least one of the following:
a beam angle associated with a reference signal;
a beam identifier associated with a reference signal;
a beam gain corresponding to a beam associated with a reference signal;
a beam width corresponding to a beam associated with a reference signal;
an antenna gain; and
beam quality.

In some implementations, the second information includes at least one of the following:
a quantization value corresponding to the target parameter, where the quantization value may be an index value corresponding to a quantization interval, or may be a normalized value; and in some implementations, quantization precision may be determined through protocol stipulation, UE reporting, network configuration, or the like;
a ratio of the target parameter to a predetermined value, a difference between the target parameter and a predetermined value, or a value obtained by adding the target parameter to a predetermined value; and
a value obtained through processing of the AI model.

The predetermined value may be a maximum value or a minimum value, such as a

maximum angle or a maximum radian. The predetermined value may also be determined through protocol stipulation, UE reporting, or network configuration. The predetermined value may also be a specific value associated with a specific target parameter stipulated in a protocol, a specific value associated with a specific target parameter reported by UE, or a specific value associated with a specific target parameter configured by a network.

In some implementations, different target parameters correspond to different predetermined values.

In some implementations, processing of the AI model may be processing of the AI model for an input parameter, or may be processing for interaction information in an information interaction process.

In this embodiment of this application, corresponding operation processing is performed based on the second information to obtain a value corresponding to the target parameter.

In addition, in this embodiment of this application, the related information of the input parameter or the output parameter may be indicated in different indication manners. For example, the related information of the input parameter is indirectly indicated by using the second information, and the related information of the output parameter is directly indicated by using the first information.

In some implementations, the related information of the beam angle or the related information of the beam identifier is represented by two-dimensional component information. For example, the beam angle is represented by a horizontal angle and a vertical angle. Certainly, the related information of the beam angle or the related information of the beam identifier may also be represented by using component information of a higher dimension.

In some implementations, in this embodiment of this application, the beam angle may be determined based on a Global Coordinate System (GCS) or a Local Coordinate System (LCS).

In some implementations, in a case that the beam angle is determined based on the local coordinate system, an origin of the local coordinate system is location information corresponding to the first communication device or location information corresponding to a second communication device.

In some implementations, in a case that the beam angle is determined based on the local coordinate system, an origin of the local coordinate system is determined through network configuration, determined through protocol stipulation, or determined through reporting of a communication device.

The reference signal in this embodiment of this application includes at least one of the following:
a reference signal configured for beam measurement;
a configured reference signal;
a pre-activated reference signal configured for beam measurement;
an activated reference signal configured for beam measurement;
a sent reference signal configured for beam measurement; and
reference information output by the AI model.

In some implementations, the order information of the parameter information includes at least one of the following:
first order information, where the first order information is used to indicate an order between a plurality of pieces of parameter information of a same type;
second order information, where the second order information is used to indicate an order between at least one parameter information group and an order between different types of parameter information in the parameter information group; and
third order information, where the third order information is used to indicate at least an order between parameter information of at least two periods.

In some implementations, the order information between the at least one parameter

information group is related to the first order information. That is, order information between parameter information groups may be determined according to sorting information of parameter information of a type.

In this embodiment of this application, the at least one parameter information group includes at least two different types of parameter information.

For example, if a parameter type of the parameter information is a beam ID, the first order information may be used to indicate an order between a plurality of beam IDs, for example, the first order information is a beam ID1, a beam ID2, and a beam ID3. For another example, if a parameter type of the parameter information is beam quality, the first order information may be used to indicate an order between a plurality of pieces of beam quality, for example, beam quality of a beam ID1, beam quality of a beam ID2, and beam quality of a beam ID3.

For example, if a parameter information type included in a parameter information group includes a beam ID and beam quality, the second order information may indicate that order information of parameter information in the parameter information group is a beam ID and beam quality. Then, order information between a plurality of parameter information groups may be sorted according to an order of parameter information, for example, sorted according to a beam ID. For example, if a first parameter information group includes a beam ID 1 and beam quality of the corresponding beam ID 1, and a second parameter information group includes a beam ID 2 and beam quality of the corresponding beam ID 2, the second order information may be specifically: the beam ID 1, the beam quality of the corresponding beam ID 1, the beam ID 2, and the beam quality of the corresponding beam ID 2. For another example, a third parameter information group and a fourth parameter information group are further includes. If the third parameter information group includes a beam ID 3, and the fourth parameter information group includes a beam ID4, the second order information may be the beam ID 1, and the beam quality of the corresponding beam ID 1, and the second parameter information group includes the beam ID 2, the beam quality of the corresponding beam ID 2, the beam ID3, and the beam ID4.

In this embodiment of this application, a time corresponding to the at least two periods may be a historical time, or may be a future time. For example, an input side of the AI model may be beam-related information corresponding to a historical time, and an output side may be beam-related information corresponding to a future time.

In some implementations, the first order information includes at least one of the following:
an order of transmit times of reference signals;
an order of set IDs of reference signals;
an order of resource IDs of reference signals;
an order of triggering aperiodic reference signals;
an order of beam angles associated with reference signals;
an order of priorities associated with reference signals; and
an order of beam IDs associated with reference signals.

The order information in this embodiment of this application includes a descending order, an ascending order, a time order, a priority order, a configured parameter type pattern order, a pattern order stipulated in a protocol, and the like.

In some implementations, the auxiliary parameter information includes at least one of the following:
related information of a reporting result or related information of a prediction result, for example, the prediction result is which number of result output by the AI model, or the reporting result is which number of output by the AI model;
reported parameter type information;
order information of reported parameter information;
quantity information of reported parameter information;
implicit indication information determined according to configuration or interaction information, where for example, when a reference signal is configured as repetition on (repetition on), beam quality information on each receive beam needs to be reported at s receive end; and in some implementations, a reporting mode may not be configured as none or may be configured as a full reporting mode;
a beam effective time;
a beam failure time;
beam information;
antenna information;
quantity limitation information of a reference signal;
information indicating whether the first interaction information includes an output of the AI model;
information indicating whether the first interaction information is information obtained through processing of the AI model; and
information indicating a processing manner of parameter information corresponding to the AI model.

In some implementations, the antenna information includes at least one of the following:
related information of an antenna gain;
an angle of a main lobe;
an angle of a side lobe;
a quantity of side lobes;
distribution of side lobes;
a quantity of antennas;
a horizontal coverage area corresponding to beam sweeping; and
a vertical coverage area corresponding to beam sweeping.

In some implementations, the related information of the antenna gain includes at least one of the following:
an antenna relative gain in unit of dBi;
Effective Isotropic Radiated Power (EIRP);
a beam power spectrum;
a beam angle gain;
a beam angle gain spectrum (that is, a gain of a beam relative to different angles,
   including complete or partial gain spectrum information); and

EIRP corresponding to each beam angle.

In some implementations, a quantity of parameter signals in the quantity limitation information of the reference signal may be a quantity of input reference signals of the AI model. When configured or pre-activated or activated or sent reference signals on one side exceeds a threshold (for example, an upper limit) corresponding to the quantity limitation information, the other side reports beam-related information in a non-AI model manner, and can only select reported information from the configured or pre-activated or activated or sent reference signal.

In this embodiment of this application, at least a part of the foregoing auxiliary parameter information may also be included in an output parameter and/or an input parameter.

In some implementations, the method in this embodiment of this application further includes:
indicating, by the first communication device, switching information of the beam-related usage of the AI model in an interactive manner.

The switching information may be used to indicate the AI mode to switch a beam-related usage, for example, switch from predicting space-related information of a beam to indicating a beam relationship.

The interactive manner includes at least one of protocol stipulation, network configuration, and reporting of a communication device.

In some implementations, the network configuration includes indicating the switching information through signaling.

In some implementations, the protocol stipulation includes indicating the switching information by using a special parameter configuration, a special signaling format, or the like, or indicating the switching information in a case that a preset condition is met, for example, configuring reference signals that exceed a quantity upper limit.

In this embodiment of this application, a first communication device indicates first interaction information related to a beam to a second communication device, so that the second communication device can determine, according to the first interaction information, a beam-related usage of an artificial intelligence AI model, parameter information corresponding to the beam-related usage of the AI model, quantity information related to the parameter information, and/or order information of the parameter information, thereby implementing the beam-related usage based on the AI model.

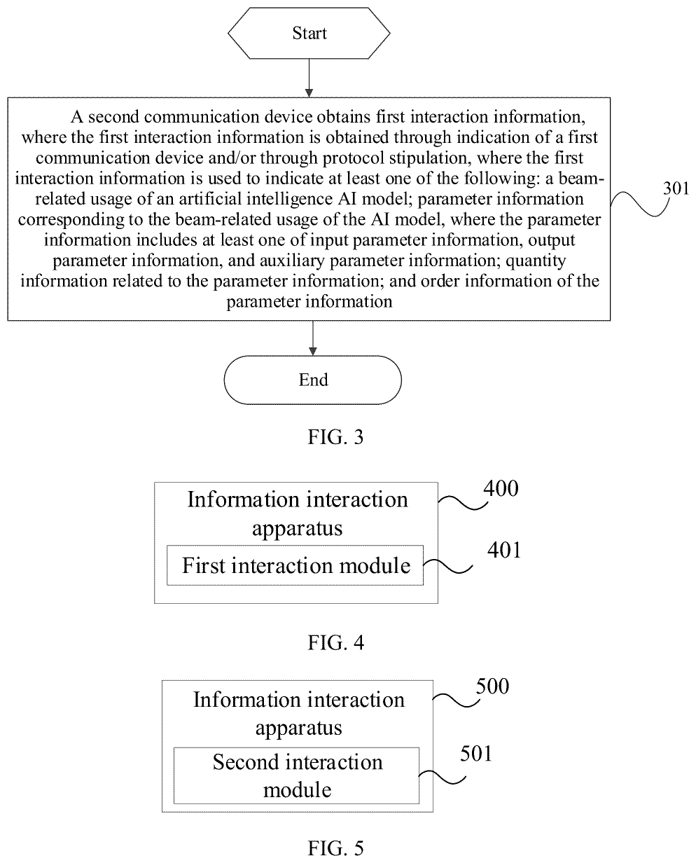

As shown in FIG. 3, an embodiment of this application further provides an information interaction method, including:
Step 301: A second communication device obtains first interaction information, where the first interaction information is obtained through indication of a first communication device and/or through protocol stipulation.

The first interaction information is used to indicate at least one of the following:
a beam-related usage of an artificial intelligence AI model;
parameter information corresponding to the beam-related usage of the AI model,
   where the parameter information includes at least one of input parameter information, output parameter information, and auxiliary parameter information;
quantity information related to the parameter information; and
order information of the parameter information.

In this embodiment of this application, a second communication device can determine, according to first interaction information, a beam-related usage of an artificial intelligence AI model, parameter information corresponding to the beam-related usage of the AI model, quantity information related to the parameter information, and/or order information of the parameter information, thereby implementing the beam-related usage based on the AI model. In some implementations, the beam-related usage of the AI model includes at least one of the following:
predicting spatial correlation information of a beam;
predicting beam information related to a target time;
adjusting a model parameter; and
indicating a beam relationship or a QCL relationship.

In some implementations, the predicting spatial correlation information of a beam includes at least one of the following:
predicting at least one beam;
predicting at least one reference signal identifier, where the reference signal identifier is associated with beam information;
predicting angle information of at least one beam; and
predicting quality information of at least one beam.

In some implementations, the quantity information related to the parameter information includes at least one of the following:
quantity information of a reference signal set;
quantity information of a reference signal resource;
information about total beam measurement times;
a total quantity of beams;
a total quantity of pieces of beam quality information;
a total quantity of beam angles;
a quantity of beam measurement periods;
information about current beam measurement times;
information about historical beam measurement times;
a quantity of beams corresponding to the information about the historical beam measurement times;
a quantity of beam angles corresponding to the information about the historical beam measurement times;
a quantity of pieces of beam quality information corresponding to the historical beam measurement information;
a quantity of beams corresponding to the current beam measurement times;
a quantity of beam angles corresponding to the current beam measurement times;
a quantity of pieces of beam quality information corresponding to the current beam measurement times; and
a total quantity of inputs of the parameter information.

In some implementations, the input parameter information or the output parameter information includes at least one of the following:
a SINR;
RSRP;
RSRQ;
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal;
related information of an antenna gain;
related information of beam quality;
related information of a beam angle;
related information of a beam receive angle indicating an output of the AI model; and
related information of a beam receive identifier indicating an output of the AI model.

In some implementations, related information of a target parameter includes at least one of the following:
first information, where the first information directly indicates a value of the target parameter; and
second information, where the second information indirectly indicates a value of the target parameter, where
the target parameter includes at least one of the following:
a beam angle associated with a reference signal;
a beam identifier associated with a reference signal;
a beam gain corresponding to a beam associated with a reference signal;
a beam width corresponding to a beam associated with a reference signal;
an antenna gain; and
beam quality.

In some implementations, the second information includes at least one of the following:
a quantization value corresponding to the target parameter;
a ratio of the target parameter to a predetermined value, a difference between the target parameter and a predetermined value, or a value obtained by adding the target parameter to a predetermined value; and
a value obtained through processing of the AI model.

In some implementations, the related information of the beam angle or the related information of the beam identifier is represented by two-dimensional component information.

In some implementations, the beam angle is determined based on a global coordinate system or a local coordinate system.

In some implementations, in a case that the beam angle is determined based on the

local coordinate system, an origin of the local coordinate system is location information corresponding to the first communication device or location information corresponding to a second communication device.

In some implementations, in a case that the beam angle is determined based on the local coordinate system, an origin of the local coordinate system is determined through network configuration, determined through protocol stipulation, or determined through reporting of a communication device.

In some implementations, the order information of the parameter information includes at least one of the following:
first order information, where the first order information is used to indicate an order between a plurality of pieces of parameter information of a same type;
second order information, where the second order information is used to indicate an order between at least one parameter information group and an order between different types of parameter information in the parameter information group; and
third order information, where the third order information is used to indicate at least information about an order between parameter information of at least two periods.

In some implementations, the first order information includes at least one of the following:
an order of transmit times of reference signals;
an order of set IDs of reference signals;
an order of resource IDs of reference signals;
an order of triggering aperiodic reference signals;
an order of beam angles associated with reference signals;
an order of priorities associated with reference signals; and
an order of beam IDs associated with reference signals.

In some implementations, the order information between the at least one parameter information group is related to the first order information.

In some implementations, the auxiliary parameter information includes at least one of the following:
related information of a reporting result or related information of a prediction result; reported parameter type information;
order information of reported parameter information;
quantity information of reported parameter information;
implicit indication information determined according to configuration or interaction information;
a beam effective time;
a beam failure time;
beam information;
antenna information;
quantity limitation information of a reference signal;
information indicating whether the first interaction information includes an output of the AI model;
information indicating whether the first interaction information is information obtained through processing of the AI model; and
information indicating a processing manner of parameter information corresponding to the AI model.

In some implementations, the antenna information includes at least one of the following:
related information of an antenna gain;
an angle of a main lobe;
an angle of a side lobe;
a quantity of side lobes;
distribution of side lobes;
a quantity of antennas;
a horizontal coverage area corresponding to beam sweeping; and
a vertical coverage area corresponding to beam sweeping.

In some implementations, in this embodiment of this application, the method further includes:
determining, by the second communication device, switching information of the beam-related usage of the AI model in an interactive manner.

It should be noted that, the information interaction method on the second communication device side is an interaction manner corresponding to the information interaction method on the first communication device side, and details are not described herein again.

According to the method in this embodiment of this application, a second communication device can determine, according to first interaction information, a beam-related usage of an artificial intelligence AI model, parameter information corresponding to the beam-related usage of the AI model, quantity information related to the parameter information, and/or order information of the parameter information, thereby implementing the beam-related usage based on the AI model.

The information interaction method provided in the embodiments of this application may be performed by an information interaction apparatus. In the embodiments of this application, an example in which the information interaction apparatus performs the information interaction method is used to describe the information interaction apparatus provided in the embodiments of this application.

As shown in FIG. 4, an embodiment of this application provides an information interaction apparatus 400, including:
a first interaction module 401, configured to indicate first interaction information, where
the first interaction information is used to indicate at least one of the following:
a beam-related usage of an artificial intelligence AI model;
parameter information corresponding to the beam-related usage of the AI model, where the parameter information includes at least one of input parameter information, output parameter information, and auxiliary parameter information;
quantity information related to the parameter information; and
order information of the parameter information.

In some implementations, the apparatus in this embodiment of this application

further includes a determining module, configured to determine the first interaction information.

In some implementations, the beam-related usage of the AI model includes at least one of the following:
predicting spatial correlation information of a beam;
predicting beam information related to a target time;
adjusting a model parameter; and
indicating a beam relationship or a QCL relationship.

In some implementations, the predicting spatial correlation information of a beam includes at least one of the following:
predicting at least one beam;
predicting at least one reference signal identifier, where the reference signal identifier is associated with beam information;
predicting angle information of at least one beam; and
predicting quality information of at least one beam.

In some implementations, the quantity information related to the parameter information includes at least one of the following:
quantity information of a reference signal set;
quantity information of a reference signal resource;
information about total beam measurement times;
a total quantity of beams;
a total quantity of pieces of beam quality information;
a total quantity of beam angles;
a quantity of beam measurement periods;
information about current beam measurement times;
information about historical beam measurement times;
a quantity of beams corresponding to the information about the historical beam measurement times;
a quantity of beam angles corresponding to the information about the historical beam measurement times;
a quantity of pieces of beam quality information corresponding to the historical beam measurement information;
a quantity of beams corresponding to the current beam measurement times;
a quantity of beam angles corresponding to the current beam measurement times;
a quantity of pieces of beam quality information corresponding to the current beam measurement times; and
a total quantity of inputs of the parameter information.

In some implementations, the input parameter information or the output parameter information includes at least one of the following:
a SINR;
RSRP;
RSRQ;
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal;
related information of an antenna gain;
related information of beam quality;
related information of a beam angle;
related information of a beam receive angle indicating an output of the AI model; and
related information of a beam receive identifier indicating an output of the AI model.

In some implementations, related information of a target parameter includes at least one of the following:
first information, where the first information directly indicates a value of the target parameter; and
second information, where the second information indirectly indicates a value of the target parameter, where
the target parameter includes at least one of the following:
a beam angle associated with a reference signal;
a beam identifier associated with a reference signal;
a beam gain corresponding to a beam associated with a reference signal;
a beam width corresponding to a beam associated with a reference signal;
an antenna gain; and
beam quality.

In some implementations, the second information includes at least one of the following:
a quantization value corresponding to the target parameter;
a ratio of the target parameter to a predetermined value, a difference between the target parameter and a predetermined value, or a value obtained by adding the target parameter to a predetermined value; and
a value obtained through processing of the AI model.

In some implementations, the related information of the beam angle or the related information of the beam identifier is represented by two-dimensional component information.

In some implementations, the beam angle is determined based on a global coordinate system or a local coordinate system.

In some implementations, in a case that the beam angle is determined based on the local coordinate system, an origin of the local coordinate system is location information corresponding to the first communication device or location information corresponding to a second communication device.

In some implementations, in a case that the beam angle is determined based on the local coordinate system, an origin of the local coordinate system is determined through network configuration, determined through protocol stipulation, or determined through reporting of a communication device.

In some implementations, the order information of the parameter information includes at least one of the following:
first order information, where the first order information is used to indicate an order between a plurality of pieces of parameter information of a same type;
second order information, where the second order information is used to indicate an order between at least one parameter information group and an order between different types of parameter information in the parameter information group; and
third order information, where the third order information is used to indicate at least information about an order between parameter information of at least two periods.

In some implementations, the first order information includes at least one of the following:
an order of transmit times of reference signals;
an order of set IDs of reference signals;
an order of resource IDs of reference signals;
an order of triggering aperiodic reference signals;
an order of beam angles associated with reference signals;
an order of priorities associated with reference signals; and
an order of beam IDs associated with reference signals.

In some implementations, the order information between the at least one parameter information group is related to the first order information.

In some implementations, the auxiliary parameter information includes at least one of the following:
related information of a reporting result or related information of a prediction result;
reported parameter type information;
order information of reported parameter information;
quantity information of reported parameter information;
implicit indication information determined according to configuration or interaction information;
a beam effective time;
a beam failure time;
beam information;
antenna information;
quantity limitation information of a reference signal;
information indicating whether the first interaction information includes an output of the AI model;
information indicating whether the first interaction information is information obtained through processing of the AI model; and
information indicating a processing manner of parameter information corresponding to the AI model.

In some implementations, the antenna information includes at least one of the following:
related information of an antenna gain;
an angle of a main lobe;
an angle of a side lobe;
a quantity of side lobes;
distribution of side lobes;
a quantity of antennas;
a horizontal coverage area corresponding to beam sweeping; and
a vertical coverage area corresponding to beam sweeping.

In some implementations, the apparatus in this embodiment of this application further includes:
a third interaction module, configured to indicate switching information of the beam-related usage of the AI model in an interactive manner.

In this embodiment of this application, a first communication device indicates first interaction information related to a beam to a second communication device, so that the second communication device can determine, according to the first interaction information, a beam-related usage of an artificial intelligence AI model, parameter information corresponding to the beam-related usage of the AI model, quantity information related to the parameter information, and/or order information of the parameter information, thereby implementing the beam-related usage based on the AI model.

As shown in FIG. 5, an embodiment of this application provides an information interaction apparatus 500, including:
a second interaction module 501, configured to obtain first interaction information, where the first interaction information is obtained through indication of a first communication device and/or through protocol stipulation, where
the first interaction information is used to indicate at least one of the following:
a beam-related usage of an artificial intelligence AI model;
parameter information corresponding to the beam-related usage of the A1 model, where the parameter information includes at least one of input parameter information, output parameter information, and auxiliary parameter information;
quantity information related to the parameter information; and
order information of the parameter information.

In some implementations, the apparatus in this embodiment of this application further includes a processing module, configured to process the first interaction information based on the AI model.

In some implementations, the beam-related usage of the AI model includes at least one of the following:
predicting spatial correlation information of a beam;
predicting beam information related to a target time;
adjusting a model parameter; and
indicating a beam relationship or a QCL relationship.

In some implementations, the predicting spatial correlation information of a beam includes at least one of the following:
predicting at least one beam;
predicting at least one reference signal identifier, where the reference signal identifier is associated with beam information;
predicting angle information of at least one beam; and
predicting quality information of at least one beam.

In some implementations, the quantity information related to the parameter information includes at least one of the following:
quantity information of a reference signal set;
quantity information of a reference signal resource;
information about total beam measurement times;
a total quantity of beams;
a total quantity of pieces of beam quality information;
a total quantity of beam angles;
a quantity of beam measurement periods;
information about current beam measurement times;
information about historical beam measurement times;
a quantity of beams corresponding to the information about the historical beam measurement times;
a quantity of beam angles corresponding to the information about the historical beam measurement times;
a quantity of pieces of beam quality information corresponding to the historical beam measurement information;
a quantity of beams corresponding to the current beam measurement times;
a quantity of beam angles corresponding to the current beam measurement times;
a quantity of pieces of beam quality information corresponding to the current beam measurement times; and
a total quantity of inputs of the parameter information.

In some implementations, the input parameter information or the output parameter information includes at least one of the following:
a SINR;
RSRP;
RSRQ;
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal;
related information of an antenna gain;
related information of beam quality;
related information of a beam angle;
related information of a beam receive angle indicating an output of the AI model; and
related information of a beam receive identifier indicating an output of the AI model.

In some implementations, related information of a target parameter includes at least one of the following:
first information, where the first information directly indicates a value of the target parameter; and
second information, where the second information indirectly indicates a value of the target parameter, where
the target parameter includes at least one of the following:
a beam angle associated with a reference signal;
a beam identifier associated with a reference signal;
a beam gain corresponding to a beam associated with a reference signal;
a beam width corresponding to a beam associated with a reference signal;
an antenna gain; and
beam quality.

In some implementations, the second information includes at least one of the following:
a quantization value corresponding to the target parameter;
a ratio of the target parameter to a predetermined value, a difference between the target parameter and a predetermined value, or a value obtained by adding the target parameter to a predetermined value; and
a value obtained through processing of the AI model.

In some implementations, the related information of the beam angle or the related information of the beam identifier is represented by two-dimensional component information.

In some implementations, the beam angle is determined based on a global coordinate system or a local coordinate system.

In some implementations, in a case that the beam angle is determined based on the local coordinate system, an origin of the local coordinate system is location information corresponding to the first communication device or location information corresponding to a second communication device.

In some implementations, in a case that the beam angle is determined based on the

local coordinate system, an origin of the local coordinate system is determined through network configuration, determined through protocol stipulation, or determined through reporting of a communication device.

In some implementations, the order information of the parameter information includes at least one of the following:
first order information, where the first order information is used to indicate an order between a plurality of pieces of parameter information of a same type;
second order information, where the second order information is used to indicate an order between at least one parameter information group and an order between different types of parameter information in the parameter information group; and
third order information, where the third order information is used to indicate at least information about an order between parameter information of at least two periods.

In some implementations, the first order information includes at least one of the following:
an order of transmit times of reference signals;
an order of set IDs of reference signals;
an order of resource IDs of reference signals;
an order of triggering aperiodic reference signals;
an order of beam angles associated with reference signals;
an order of priorities associated with reference signals; and
an order of beam IDs associated with reference signals.

In some implementations, the order information between the at least one parameter information group is related to the first order information.

In some implementations, the auxiliary parameter information includes at least one of the following:
related information of a reporting result or related information of a prediction result;
reported parameter type information;
order information of reported parameter information;
quantity information of reported parameter information;
implicit indication information determined according to configuration or interaction information;
a beam effective time;
a beam failure time;
beam information;
antenna information;
quantity limitation information of a reference signal;
information indicating whether the first interaction information includes an output of the AI model;
information indicating whether the first interaction information is information obtained through processing of the AI model; and
information indicating a processing manner of parameter information corresponding to the AI model.

In some implementations, the antenna information includes at least one of the following:
related information of an antenna gain;
an angle of a main lobe;
an angle of a side lobe;
a quantity of side lobes;
distribution of side lobes;
a quantity of antennas;
a horizontal coverage area corresponding to beam sweeping; and
a vertical coverage area corresponding to beam sweeping.

In some implementations, the apparatus in this embodiment of this application further includes:
a fourth determining module, configured to determine switching information of the beam-related usage of the AI model in an interactive manner.

According to the apparatus in this embodiment of this application, a beam-related usage of an artificial intelligence AI model, parameter information corresponding to the beam-related usage of the AI model, quantity information related to the parameter information, and/or order information of the parameter information can be determined according to first interaction information, thereby implementing the beam-related usage based on the AI model.

The information interaction apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a Network Attached Storage (NAS), or the like. This is not specifically limited in this embodiment of this application.

The information interaction apparatus provided in this embodiment of this application can implement the processes implemented in the method embodiment of FIG. 2 or FIG. 3, and achieve a same technical effect. To avoid repetition, details are not described herein again.

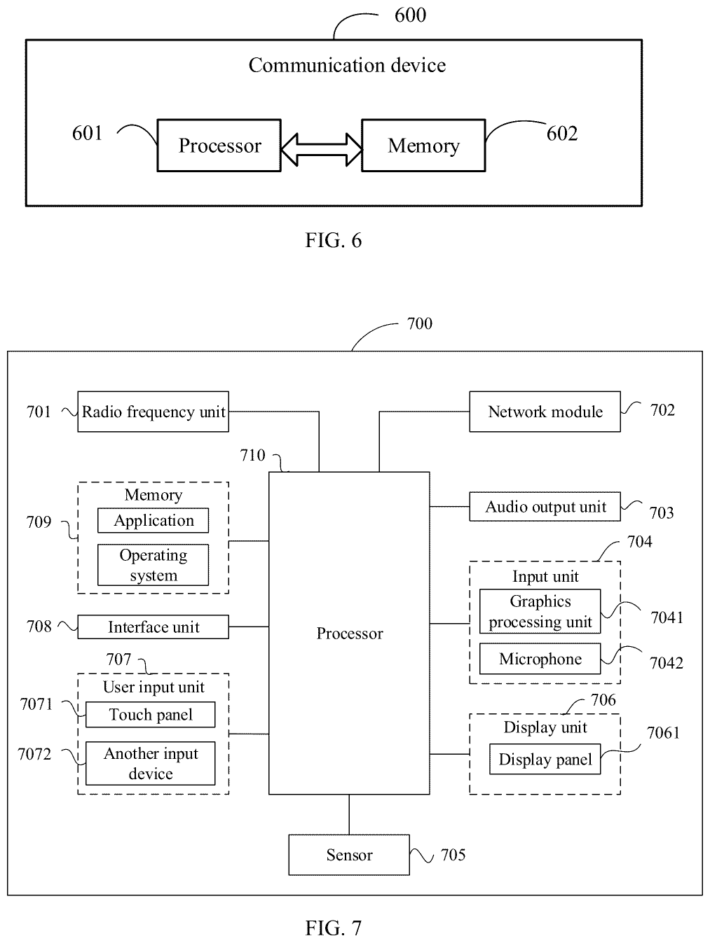

In some implementations, as shown in FIG. 6, an embodiment of this application

further provides a communication device 600, including a processor 601 and a memory 602. The memory 602 stores a program or an instruction that can be run on the processor 601. For example, when the communication device 600 is a first communication device, the program or the instruction is executed by the processor 601 to implement the steps of the foregoing information interaction method embodiment on the first communication device side, and a same technical effect can be achieved. When the communication device 600 is a second communication device, the program or the instruction is executed by the processor 601 to implement the steps of the foregoing information interaction method embodiment on the second communication device side, and a same technical effect can be achieved. To avoid repetition, details are not described herein again.

An embodiment of this application further provides a communication device, including a processor and a communication interface. The communication interface is configured to indicate first interaction information, where the first interaction information is used to indicate at least one of the following:
a beam-related usage of an artificial intelligence AI model;
parameter information corresponding to the beam-related usage of the AI model, where the parameter information includes at least one of input parameter information, output parameter information, and auxiliary parameter information;
quantity information related to the parameter information; and
order information of the parameter information.

This communication device embodiment corresponds to the foregoing method embodiment on the first communication device side. Each implementation process and implementation of the foregoing method embodiment may be applicable to this communication device embodiment, and a same technical effect can be achieved.

An embodiment of this application further provides a communication device, including a processor and a communication interface. The communication interface or the processor is configured to obtain first interaction information, where the first interaction information is obtained through indication of a first communication device and/or through protocol stipulation, where
the first interaction information is used to indicate at least one of the following:
a beam-related usage of an artificial intelligence AI model;
parameter information corresponding to the beam-related usage of the AI model, where the parameter information includes at least one of input parameter information, output parameter information, and auxiliary parameter information;
quantity information related to the parameter information; and
order information of the parameter information.

This communication device embodiment corresponds to the foregoing method embodiment on the second communication device side. Each implementation process and implementation of the foregoing method embodiment may be applicable to this communication device embodiment, and a same technical effect can be achieved.

In some implementations, the first communication device or the second communication device may be a terminal. FIG. 7 is a schematic diagram of a hardware structure of a terminal according to an embodiment of this application.

A terminal 700 includes but is not limited to components such as a radio frequency

unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 709 in this embodiment of this application includes but is not limited to these memories and a memory of any other proper type.

The processor 710 may include one or more processing units. In some implementations, an application processor and a modem processor are integrated into the processor 710. The application processor mainly processes an operating system, a user interface, an application, and the like. The modem processor mainly processes a wireless communication signal, for example, a baseband processor. It can be understood that, alternatively, the modem processor may not be integrated into the processor 710.

In an embodiment of this application, the radio frequency unit 701 is configured to indicate first interaction information.

In another embodiment of this application, the processor 710 and/or the radio frequency unit 701 are/is configured to obtain first interaction information, where the first interaction information is obtained through indication of a first communication device and/or through protocol stipulation.

The first interaction information is used to indicate at least one of the following:
a beam-related usage of an artificial intelligence AI model;
parameter information corresponding to the beam-related usage of the AI model, where the parameter information includes at least one of input parameter information, output parameter information, and auxiliary parameter information;
quantity information related to the parameter information; and
order information of the parameter information.

In some implementations, the beam-related usage of the AI model includes at least one of the following:
predicting spatial correlation information of a beam;
predicting beam information related to a target time;
adjusting a model parameter; and
indicating a beam relationship or a quasi co-location QCL relationship.

In some implementations, the predicting spatial correlation information of a beam includes at least one of the following:
predicting at least one beam;
predicting at least one reference signal identifier, where the reference signal identifier is associated with beam information;
predicting angle information of at least one beam; and
predicting quality information of at least one beam.

In some implementations, the quantity information related to the parameter information includes at least one of the following:
quantity information of a reference signal set;
quantity information of a reference signal resource;
information about total beam measurement times;
a total quantity of beams;
a total quantity of pieces of beam quality information;
a total quantity of beam angles;
a quantity of beam measurement periods;
information about current beam measurement times;
information about historical beam measurement times;
a quantity of beams corresponding to the information about the historical beam measurement times;
a quantity of beam angles corresponding to the information about the historical beam measurement times;
a quantity of pieces of beam quality information corresponding to the historical beam measurement information;
a quantity of beams corresponding to the current beam measurement times;
a quantity of beam angles corresponding to the current beam measurement times;
a quantity of pieces of beam quality information corresponding to the current beam measurement times; and
a total quantity of inputs of the parameter information.

In some implementations, the input parameter information or the output parameter information includes at least one of the following:
a SINR;
RSRP;
RSRQ;
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal;
related information of an antenna gain;
related information of beam quality;
related information of a beam angle;
related information of a beam receive angle indicating an output of the AI model; and
related information of a beam receive identifier indicating an output of the AI model.

In some implementations, related information of a target parameter includes at least one of the following:
first information, where the first information directly indicates a value of the target parameter; and
second information, where the second information indirectly indicates a value of the target parameter, where
the target parameter includes at least one of the following:
a beam angle associated with a reference signal;
a beam identifier associated with a reference signal;
a beam gain corresponding to a beam associated with a reference signal;
a beam width corresponding to a beam associated with a reference signal;
an antenna gain; and
beam quality.

In some implementations, the second information includes at least one of the following:
a quantization value corresponding to the target parameter;
a ratio of the target parameter to a predetermined value, a difference between the target parameter and a predetermined value, or a value obtained by adding the target parameter to a predetermined value; and
a value obtained through processing of the AI model.

In some implementations, the related information of the beam angle or the related information of the beam identifier is represented by two-dimensional component information.

In some implementations, the beam angle is determined based on a global coordinate system or a local coordinate system.

In some implementations, in a case that the beam angle is determined based on the local coordinate system, an origin of the local coordinate system is location information corresponding to the first communication device or location information corresponding to a second communication device.

In some implementations, in a case that the beam angle is determined based on the local coordinate system, an origin of the local coordinate system is determined through network configuration, determined through protocol stipulation, or determined through reporting of a communication device.

In some implementations, the order information of the parameter information includes at least one of the following:
first order information, where the first order information is used to indicate an order between a plurality of pieces of parameter information of a same type;
second order information, where the second order information is used to indicate an order between at least one parameter information group and an order between different types of parameter information in the parameter information group; and
third order information, where the third order information is used to indicate at least information about an order between parameter information of at least two periods.

In some implementations, the first order information includes at least one of the following:
an order of transmit times of reference signals;
an order of set IDs of reference signals;
an order of resource IDs of reference signals;
an order of triggering aperiodic reference signals;
an order of beam angles associated with reference signals;
an order of priorities associated with reference signals; and
an order of beam IDs associated with reference signals.

In some implementations, the order information between the at least one parameter information group is related to the first order information.

In some implementations, the auxiliary parameter information includes at least one

of the following:
related information of a reporting result or related information of a prediction result;
reported parameter type information;
order information of reported parameter information;
quantity information of reported parameter information;
implicit indication information determined according to configuration or interaction information;
a beam effective time;
a beam failure time;
beam information;
antenna information;
quantity limitation information of a reference signal;
information indicating whether the first interaction information includes an output of the AI model;
information indicating whether the first interaction information is information obtained through processing of the AI model; and
information indicating a processing manner of parameter information corresponding to the AI model.

In some implementations, the antenna information includes at least one of the following:
related information of an antenna gain;
an angle of a main lobe;
an angle of a side lobe;
a quantity of side lobes;
distribution of side lobes;
a quantity of antennas;
a horizontal coverage area corresponding to beam sweeping; and
a vertical coverage area corresponding to beam sweeping.

In some implementations, in an embodiment of this application, the radio frequency unit 701 is configured to indicate switching information of the beam-related usage of the AI model in an interactive manner.

In some implementations, in an embodiment of this application, the processor 710 and/or the radio frequency unit 701 are/is configured to determine switching information of the beam-related usage of the AI model in an interactive manner.

In this embodiment of this application, a beam-related usage of an artificial intelligence AI model, parameter information corresponding to the beam-related usage of the AI model, quantity information related to the parameter information, and/or order information of the parameter information can be determined according to first interaction information, thereby implementing the beam-related usage based on the AI model.

The first communication device or the second communication device in the embodiments of this application may be a network side device. In some implementations, an embodiment of this application further provides a network side device. As shown in FIG. 8, a network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network side device may be implemented in the baseband apparatus 83. The baseband apparatus 83 includes a baseband processor.

The baseband apparatus 83 may include, for example, at least one baseband board, where a plurality of chips are disposed on the baseband board. As shown in FIG. 8, one chip is, for example, the baseband processor, is connected to the memory 85 through a bus interface, to invoke a program in the memory 85 to perform the operations of the network device shown in the foregoing method embodiment.

The network side device may further include a network interface 86, and the interface is, for example, a Common Public Radio Interface (CPRI).

In some implementations, the network side device 800 in this embodiment of the present invention further includes an instruction or a program that is stored in the memory 85 and that can be run on the processor 84. The processor 84 invokes the instruction or the program in the memory 85 to perform the method performed by the modules shown in FIG. 4 or FIG. 5, and a same technical effect is achieved. To avoid repetition, details are not described herein again.

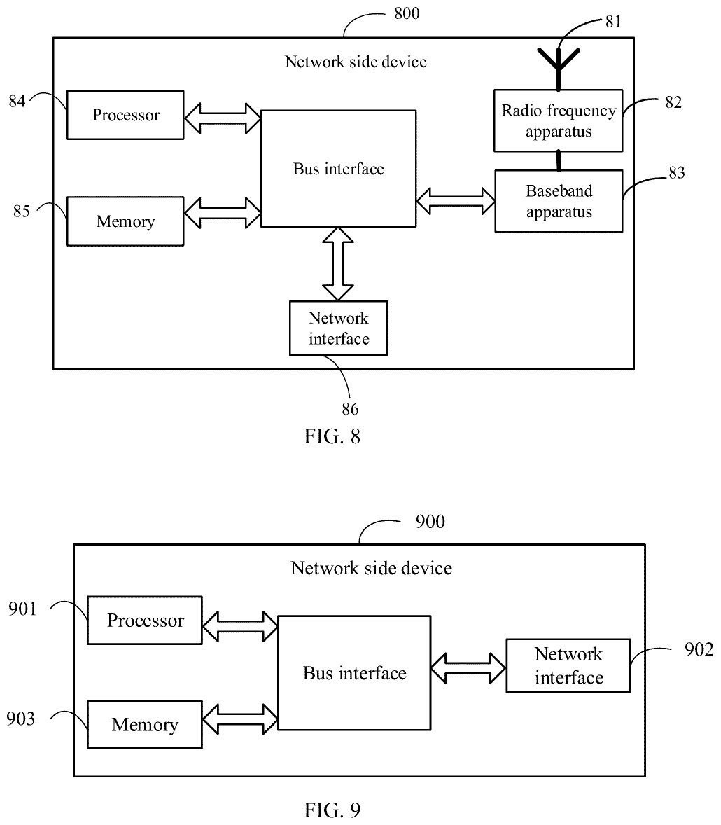

The first communication device or the second communication device in the embodiments of this application may be a network side device. In some implementations, an embodiment of this application further provides a network side device. As shown in FIG. 9, a network side device 900 includes a processor 901, a network interface 902, and a memory 903. The network interface 902 is, for example, a CPRI.

In some implementations, the network side device 900 in this embodiment of the present invention further includes an instruction or a program that is stored in the memory 903 and that can be run on the processor 901. The processor 901 invokes the instruction or the program in the memory 903 to perform the method performed by the modules shown in FIG. 4 or FIG. 5, and a same technical effect is achieved. To avoid repetition, details are not described herein again.

An embodiment of this application further provides a readable storage medium. The readable storage medium stores a program or an instruction, and the program or the instruction is executed by a processor to implement the processes in the foregoing information interaction method embodiment, and a same technical effect can be achieved. To avoid repetition, details are not described herein again.

The processor is a processor in the terminal in the foregoing embodiment. The readable storage medium includes a computer readable storage medium, such as a computer ROM, a RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing information interaction method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing information interaction method embodiment, and a same technical effect can be achieved. To avoid repetition, details are not described herein again.

An embodiment of this application further provides an information interaction system, including a first communication device and a second communication device. The communication device may be configured to perform the steps of the information interaction method applied to the first communication device, and the second communication device may be configured to perform the steps of the information interaction method applied to the second communication device.

It should be noted that, in this specification, the terms “include,” “comprise,” or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. An information interaction method, performed by a first communication device, comprising:
indicating first interaction information, wherein
the first interaction information indicates at least one of the following:
a beam-related usage of an artificial intelligence AI model;
parameter information corresponding to the beam-related usage of the AI model, wherein the parameter information comprises at least one of input parameter information, output parameter information, or auxiliary parameter information;
quantity information related to the parameter information; or
order information of the parameter information.

2. The information interaction method according to claim 1, wherein the beam-related usage of the AI model comprises at least one of the following:
predicting spatial correlation information of a beam;
predicting beam information related to a target time;
adjusting a model parameter; or
indicating a beam relationship or a Quasi Co-Location (QCL) relationship.

3. The information interaction method according to claim 2, wherein the predicting spatial correlation information of a beam comprises at least one of the following:
predicting at least one beam;
predicting at least one reference signal identifier, wherein the reference signal identifier is associated with beam information;
predicting angle information of at least one beam; or
predicting quality information of at least one beam.

4. The information interaction method according to claim 1, wherein the quantity information related to the parameter information comprises at least one of the following:
quantity information of a reference signal set;
quantity information of a reference signal resource;
information about total beam measurement times;
a total quantity of beams;
a total quantity of pieces of beam quality information;
a total quantity of beam angles;
a quantity of beam measurement periods;
information about current beam measurement times;
information about historical beam measurement times;
a quantity of beams corresponding to the information about the historical beam measurement times;
a quantity of beam angles corresponding to the information about the historical beam measurement times;
a quantity of pieces of beam quality information corresponding to the historical beam measurement information;
a quantity of beams corresponding to the current beam measurement times;
a quantity of beam angles corresponding to the current beam measurement times;
a quantity of pieces of beam quality information corresponding to the current beam measurement times; or
a total quantity of inputs of the parameter information.

5. The information interaction method according to claim 1, wherein the input parameter information or the output parameter information comprises at least one of the following:
a Signal to Interference plus Noise Ratio (SINR);
Reference Signal Received Power (RSRP);
Reference Signal Received Quality (RSRQ);
a transmit time of a reference signal;
a trigger time of an aperiodic reference signal;
a set ID corresponding to a reference signal;
a resource ID corresponding to a reference signal;
related information of a beam angle associated with a reference signal;
related information of a beam identifier associated with a reference signal;
related information of a beam gain corresponding to a beam associated with a reference signal;
related information of a beam width corresponding to a beam associated with a reference signal;
related information of an antenna gain;
related information of beam quality;
related information of a beam angle;
related information of a beam receive angle indicating an output of the AI model; or
related information of a beam receive identifier indicating an output of the AI model.

6. The information interaction method according to claim 5, wherein related information of a target parameter comprises at least one of the following:
first information, wherein the first information directly indicates a value of the target parameter; or
second information, wherein the second information indirectly indicates a value of the target parameter, wherein
the target parameter comprises at least one of the following:
a beam angle associated with a reference signal;
a beam identifier associated with a reference signal;
a beam gain corresponding to a beam associated with a reference signal;
a beam width corresponding to a beam associated with a reference signal;
an antenna gain; or
beam quality.

7. The information interaction method according to claim 6, wherein the second information comprises at least one of the following:
a quantization value corresponding to the target parameter;
a ratio of the target parameter to a predetermined value, a difference between the target parameter and a predetermined value, or a value obtained by adding the target parameter to a predetermined value; or
a value obtained through processing of the AI model.

8. The information interaction method according to claim 5, wherein the related information of the beam angle or the related information of the beam identifier is represented by two-dimensional component information.

9. The information interaction method according to claim 4, wherein the beam angle is determined based on a global coordinate system or a local coordinate system.

10. The information interaction method according to claim 9, wherein when the beam angle is determined based on the local coordinate system, an origin of the local coordinate system is location information corresponding to the first communication device or location information corresponding to a second communication device.

11. The information interaction method according to claim 9, wherein when the beam angle is determined based on the local coordinate system, an origin of the local coordinate system is determined through network configuration, determined through protocol stipulation, or determined through reporting of a communication device.

12. The information interaction method according to claim 1, wherein the order information of the parameter information comprises at least one of the following:
first order information, wherein the first order information indicates an order between a plurality of pieces of parameter information of a same type;
second order information, wherein the second order information indicates an order between at least one parameter information group and an order between different types of parameter information in the parameter information group; or
third order information, wherein the third order information indicates at least an order between parameter information of at least two periods.

13. The information interaction method according to claim 12, wherein the first order information comprises at least one of the following:
an order of transmit times of reference signals;
an order of set IDs of reference signals;
an order of resource IDs of reference signals;
an order of triggering aperiodic reference signals;
an order of beam angles associated with reference signals;
an order of priorities associated with reference signals; or
an order of beam IDs associated with reference signals.

14. The information interaction method according to claim 12, wherein the order information between the at least one parameter information group is related to the first order information.

15. The information interaction method according to claim 1, wherein the auxiliary parameter information comprises at least one of the following:
related information of a reporting result or related information of a prediction result;
reported parameter type information;
order information of reported parameter information;
quantity information of reported parameter information;
implicit indication information determined according to configuration or interaction information;
a beam effective time;
a beam failure time;
beam information;
antenna information;
quantity limitation information of a reference signal;
information indicating whether the first interaction information comprises an output of the AI model;
information indicating whether the first interaction information is information obtained through processing of the AI model; or
information indicating a processing manner of parameter information corresponding to the AI model.

16. The information interaction method according to claim 15, wherein the antenna information comprises at least one of the following:
related information of an antenna gain;
an angle of a main lobe;
an angle of a side lobe;
a quantity of side lobes;
distribution of side lobes;
a quantity of antennas;
a horizontal coverage area corresponding to beam sweeping; or
a vertical coverage area corresponding to beam sweeping.

17. The information interaction method according to claim 1, further comprising:
indicating switching information of the beam-related usage of the AI model in an interactive manner.

18. A first communication device, comprising:
a memory storing computer-readable instructions; and
a processor coupled to the memory and configured to execute the computer-readable instructions, wherein the computer-readable instructions, when executed by the processor, cause the processor to perform operations comprising:
indicating first interaction information, wherein
the first interaction information indicates at least one of the following:
a beam-related usage of an artificial intelligence AI model;
parameter information corresponding to the beam-related usage of the AI model, wherein the parameter information comprises at least one of input parameter information, output parameter information, or auxiliary parameter information;
quantity information related to the parameter information; or
order information of the parameter information.

19. The first communication device according to claim 18, wherein the beam-related usage of the AI model comprises at least one of the following:
predicting spatial correlation information of a beam;
predicting beam information related to a target time;
adjusting a model parameter; or
indicating a beam relationship or a Quasi Co-Location (QCL) relationship.

20. A non-transitory computer-readable medium storing instructions that, when executed by a processor of a first communication device, cause the processor to perform operations comprising:
indicating first interaction information, wherein
the first interaction information indicates at least one of the following:
a beam-related usage of an artificial intelligence AI model;
parameter information corresponding to the beam-related usage of the AI model, wherein the parameter information comprises at least one of input parameter information, output parameter information, or auxiliary parameter information;
quantity information related to the parameter information; or
order information of the parameter information.
